(19) United States
(12) Patent Application Publication
(10) Pub. No.: US 2022/0005439 A1
(43) Pub. Date: Jan. 6, 2022

(54) METHOD FOR DISPLAY-BRIGHTNESS ADJUSTMENT AND RELATED PRODUCTS

(71) Applicant: GUANGDONG OPPO MOBILE TELECOMMUNICATIONS CORP., LTD., Dongguan (CN)

(72) Inventors: Jie HU, Dongguan (CN); Hai YANG, Dongguan (CN)

(21) Appl. No.: 17/476,465

(22) Filed: Sep. 15, 2021

Related U.S. Application Data
(63) Continuation of application No. PCT/CN2020/078819, filed on Mar. 11, 2020.

(30) Foreign Application Priority Data
Apr. 2, 2019 (CN) 201910263506.4

(51) Int. Cl. G09G 5/10; G09G 3/20

(52) U.S. Cl. CPC G09G 5/10; G09G 3/2003; G09G 2300/0452; G09G 2340/06; G09G 2320/0626

(57) ABSTRACT

A method for display-brightness adjustment and related products are provided. The method includes the following. An AP detects a first backlight brightness in a backlight brightness progress bar. A color-space-conversion module adjusts a first group of RGB parameters of a picture to be loaded to a second group of RGB parameters according to the first backlight brightness in response to the first backlight brightness being less than a threshold. The screen displays the picture to be loaded according to the second group of RGB parameters.

### CROSS-REFERENCE TO RELATED APPLICATIONS

This application is a continuation of International Application No. PCT/CN2020/078819, filed on Mar. 11, 2020, which claims priority to Chinese Patent Application No. 201910263506.4, filed on Apr. 2, 2019, the entire disclosures of which are incorporated herein by reference.

### TECHNICAL FIELD

This disclosure relates to the technical filed of display control, and particularly to a method for display-brightness adjustment and related products.

### BACKGROUND

With electronic devices (such as mobile phones, tablet computers, etc.) being widely used, the electronic devices are becoming powerful and can support more and more applications. The Electronic devices are developing in a diversified and personalized direction and become indispensable in users' lives.

Currently, when display-brightness of a screen of the electronic device is adjusted, backlight brightness (value) is generally adjusted through a backlight brightness progress bar. However, the backlight brightness in the progress bar has a limited range, it is difficult for users to adjust the backlight brightness further. Therefore, how to improve the intelligence of display-brightness adjustment has been a problem that needs to be solved urgently.

### SUMMARY

Disclosed herein are implementations of a method for display-brightness adjustment and related products.

According to a first aspect, implementations provide a method for display-brightness adjustment. The method for display-brightness adjustment is for an electronic device, and the electronic device includes an application processor (AP), a bridge chip (IC), and a screen. The bridge IC includes a color-space-conversion module. The AP is coupled with the bridge IC, and the bridge IC is coupled with the screen. The method includes the following. The AP detects a first backlight brightness (value) in a backlight brightness progress bar. The color-space-conversion module adjusts a first group of RGB parameters of a picture to be loaded to a second group of RGB parameters according to the first backlight brightness in response to the first backlight brightness being less than a threshold. The screen displays the picture to be loaded according to the second group of RGB parameters.

According to a second aspect, implementations provide an electronic device. The electronic device includes a processor, a memory, and one or more programs stored in the memory. The one or more programs are configured to be executed by the processor and include instructions configured to perform all or part of operations of the method in the first aspect.

According to a third aspect, implementations provide a non-transitory computer-readable storage medium. The non-transitory computer-readable storage medium is configured to store a computer program for electronic data interchange. The computer program causes a computer to execute all or part of operations of the method in the first aspect.

### BRIEF DESCRIPTION OF THE DRAWINGS

To describe technical solutions in implementations of the present disclosure more clearly, the following briefly introduces accompanying drawings required for illustrating the implementations. Apparently, the accompanying drawings in the following description illustrate some implementations of the present disclosure. Those of ordinary skill in the art may also obtain other drawings based on these accompanying drawings without creative efforts.

FIG. 1 is a schematic structural diagram illustrating an electronic device according to implementations.

FIG. 2 is a schematic flow chart illustrating a method for display-brightness adjustment according to implementations.

FIG. 3 is a schematic diagram illustrating various components in an electronic device implementing a method for display-brightness adjustment according to implementations.

FIG. 4 is a schematic flow chart illustrating a method for display-brightness adjustment according to other implementations.

FIG. 5 is a schematic flow chart illustrating a method for display-brightness adjustment according to other implementations.

FIG. 6 is a schematic structural diagram illustrating an electronic device according to other implementations.

FIG. 7 is a schematic structural diagram illustrating an apparatus for display-brightness adjustment according to implementations.

FIG. 8 is a schematic structural diagram illustrating an electronic device according to other implementations.

### DETAILED DESCRIPTION

Technical solutions in implementations of the present disclosure will be described clearly and completely hereinafter with reference to the accompanying drawings described. Apparently, the described implementations are merely some rather than all implementations of the present disclosure. All other implementations obtained by those of ordinary skill in the art based on the implementations of the present disclosure without creative efforts shall fall within the protection scope of the present disclosure.

The terms “first”, “second”, and the like used in the specification, the claims, and the accompany drawings of the present disclosure are used to distinguish different objects rather than describe a particular order. The terms “include”, “comprise”, and “have” as well as variations thereof are intended to cover non-exclusive inclusion. For example, a process, method, system, product, or apparatus including a series of steps or units is not limited to the listed steps or units, on the contrary, it can optionally include other steps or units that are not listed; alternatively, other steps or units inherent to the process, method, product, or device can be included either.

The term “implementation” referred to herein means that a particular feature, structure, or feature described in conjunction with the implementation may be contained in at least one implementation of the present disclosure. The phrase appearing in various places in the specification does not necessarily refer to the same implementation, nor does it refer to an independent or alternative implementation that is mutually exclusive with other implementations. It is expressly and implicitly understood by those skilled in the art that an implementation described herein may be combined with other implementations.

The electronic devices involved in the implementations of the present application may be electronic devices with data transmission capabilities. The electronic device may include various handheld devices, in-vehicle devices, wearable devices, computing devices that have wireless communication functions or other processing devices connected to the wireless modem, as well as various forms of user equipment (UE), mobile stations (MS), terminal devices, and the like. For the convenience of description, the above-mentioned devices are collectively referred to as an electronic device.

Hereinafter, the implementations of the disclosure will be interpreted in detail.

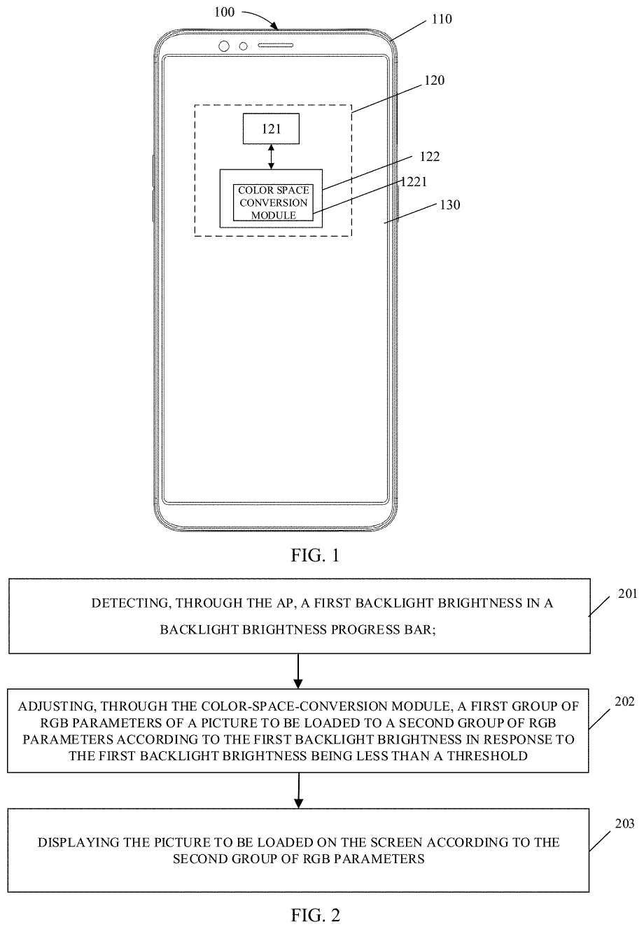

FIG. 1 is a schematic structural diagram illustrating an electronic device 100 according to implementations. As illustrated in FIG. 1, the electronic device 100 includes a housing 110, a circuit board 120 disposed in the housing 110, and a screen 130 disposed on the housing 110. The circuit board 120 is provided with an application processor (AP) 121 and a bridge chip (IC) 122, the bridge IC122 includes a color-space-conversion module 1221, the AP 121 is coupled with the bridge IC122, and the bridge IC122 is coupled with the screen 130. The screen 130 can be configured to display an interface for screen brightness adjustment. The interface for screen brightness adjustment has a backlight brightness progress bar, and backlight brightness progress is used for indicating current screen brightness.

It is to be noted that, the color-space-conversion module 1221 described in the disclosure should be understood as the broadest meaning as possible, and an object for implementing functions of color space conversion, for example, an integrated circuit (ASIC), a single circuit, a processor (shared, dedicated, or chipset) and a memory for executing one or more software or firmware programs, a combinational logic circuit, and/or other suitable components that can achieve the above described functions.

The AP is configured to detect a first backlight brightness (value) in the backlight brightness progress bar. The color-space-conversion module 1221 is configured to adjust a first group of RGB parameters of a picture to be loaded to a second group of RGB parameters according to the first backlight brightness in response to the first backlight brightness being less than a threshold. The screen is configured to display the picture to be loaded according to the second group of RGB parameters.

As an implementation, in terms of adjusting, through the color-space-conversion module 1221, the first group of RGB parameters of the picture to be loaded to the second group of RGB parameters according to the first backlight brightness, the color-space-conversion module 1221 is configured to: obtain a first group of YCbCr parameters by converting the first group of RGB parameters into YCbCr parameters; obtain a second group of YCbCr parameters, by adjusting the first group of YCbCr parameters according to the first backlight brightness; convert the second group of YCbCr parameters to the second group of RGB parameters.

As an implementation, in terms of obtaining the second group of YCbCr parameters, by adjusting the first group of YCbCr parameters according to the first backlight brightness, the color-space-conversion module 1221 is configured to: determine a target adjustment coefficient according to the first backlight brightness; obtain an adjusted luma component, by adjusting a luma component in the first group of YCbCr parameters according to the target adjustment coefficient, and determine a blue chrominance component and a red chrominance component in the first group of YCbCr parameters and (as well as) the adjusted luma component as the second group of YCbCr parameters.

As an implementation, in terms of determining the target adjustment coefficient according to the first backlight brightness, the color-space-conversion module 1221 is configured to: search for an adjustment coefficient corresponding to the first backlight brightness from an adjustment coefficient list; determine the adjustment coefficient corresponding to the first backlight brightness as the target adjustment coefficient on condition that the first backlight brightness exists in the adjustment coefficient list.

As an implementation, in terms of determining the target adjustment coefficient according to the first backlight brightness, the color-space-conversion module 1221 is configured to: obtain multiple backlight brightness samples and obtain multiple adjustment coefficients corresponding to each of the multiple backlight brightness samples (that is, obtain multiple adjustment coefficients by obtaining an adjustment coefficient corresponding to each of the multiple backlight brightness samples); obtain a fitting function by performing fitting according to the multiple backlight brightness samples and the multiple adjustment coefficients; determine the target adjustment coefficient according to the first backlight brightness and the fitting function.

As an implementation, the AP is further configured to select a target pixel area in the picture to be loaded after the color-space-conversion module 1221 obtains the adjusted luma component by adjusting the luma component in the first group of YCbCr parameters according to the target adjustment coefficient, pixels in the target pixel area having a luma component greater than a preset luma component. The display is further configured to: display the target pixel area in the picture to be loaded according to the second group of RGB parameters; display pixels not in the target pixel area according to the first group of RGB parameters.

As an implementation, the AP is further configured to select a target pixel area in the picture to be loaded after the AP detects the first backlight brightness in the backlight brightness progress bar, where pixels in the target pixel area have a luma component greater than a preset luma component; the color-space-conversion module configured to adjust the first group of RGB parameters of the picture to be loaded to the second group of RGB parameters according to the first backlight brightness is configured to adjust the first group of RGB parameters of the target pixel area in the picture to be loaded to the second group of RGB parameters according to the first backlight brightness comprises; the screen configured to display the picture to be loaded according to the second group of RGB parameters is configured to display the target pixel area in the picture to be loaded according to the second group of RGB parameters.

As an implementation, the screen is further configured to display pixels not in the target pixel area according to the first group of RGB parameters.

FIG. 2 is a schematic flow chart illustrating a method for display-brightness adjustment according to implementations. The method for display-brightness adjustment described in the implementations is for (applicable to) an electronic device as illustrated in FIG. 1. The electronic device includes an application processor (AP), a bridge chip (IC), and a screen. The bridge IC includes a color-space-conversion module. The AP is coupled with the bridge IC and the bridge IC is coupled with the screen. As illustrated in FIG. 1, the method includes the following.

At block 201, the AP detects a first backlight brightness in a backlight brightness progress bar.

In the implementations of the present disclosure, backlight brightness of the screen can be adjusted through the backlight brightness progress bar, and the AP of the electronic device can detect the current first backlight brightness in the backlight brightness progress bar.

At block 202, the color-space-conversion module adjusts a first group of RGB parameters of a picture to be loaded to a second group of RGB parameters according to the first backlight brightness in response to the first backlight brightness being less than a threshold.

The first group of RGB parameters includes, for each pixel in a picture to be loaded, a luma component for red (i.e. an intensity of red) R₁, a luma component for green (i.e. an intensity of green) G₁, and a luma component for blue (i.e. an intensity of blue) B₁; the second group of RGB parameters includes, for each pixel in the picture to be loaded, an adjusted luma component for red R₂, an adjusted luma component for green G₂, and an adjusted luma component for blue B₂.

The threshold refers to a brightness threshold set in advance. The threshold can be set by a user or set by default by a system of the electronic device. The threshold is less than or equal to 256, and for example, the threshold may be 256.

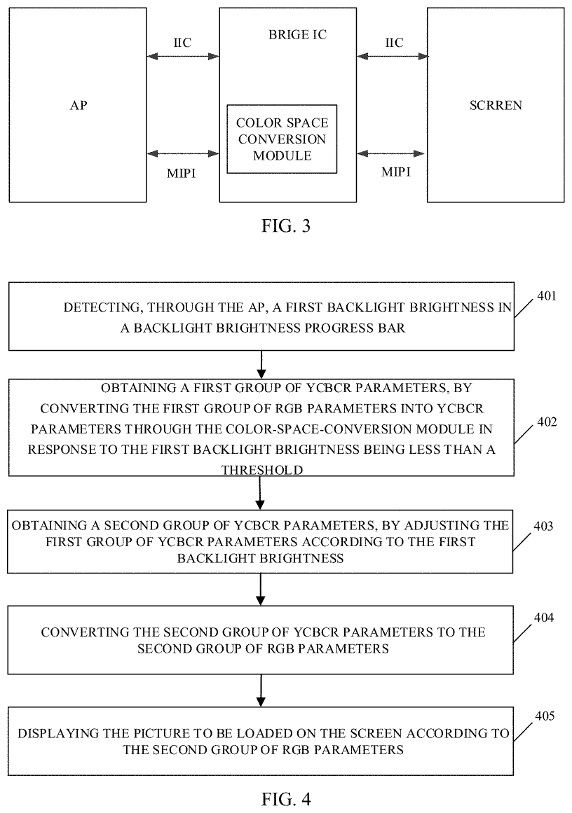

FIG. 3 is a schematic diagram illustrating various components in an electronic device implementing a method for display-brightness adjustment according to implementations. As illustrated in FIG. 3, in implementations of the present disclosure, when the user adjusts the backlight brightness of the screen to be lower than the threshold and the user wants to adjust the screen to a lower brightness, the first group of RGB parameters of the picture to be loaded can be adjusted to the second group of RGB parameters according to the first backlight brightness. Specifically, on condition that the AP detects that the first backlight brightness is less than the threshold, display information of the picture to be loaded can be transmitted to the bridge IC through a mobile industry processor interface (MIPI) bus. The display information includes, for each pixel in a picture to be loaded, the luma component for red (i.e. an intensity of red) R₁, the luma component for green (i.e. an intensity of green) G₁, and the luma component for blue (i.e. an intensity of blue) B₁. In addition, an adjustment instruction indicative of adjusting the first group of RGB parameters to the second group of RGB parameter can be also sent to the bridge IC via an inter-integrated circuit (IIC) bus. After the bridge IC receives the adjustment instruction, the bridge IC converts, through the color-space-conversion module, the first group of RGB parameters of the picture to be loaded to the second group of RGB parameters according to the first backlight brightness.

As an implementation, at block 202, the color-space-conversion module adjusts the first group of RGB parameters of the picture to be loaded to the second group of RGB parameters according to the first backlight brightness as follows.

The color-space-conversion module obtains a first group of YCbCr parameters, by converting the first group of RGB parameters into YCbCr parameters. The color-space-conversion module obtains a second group of YCbCr parameters, by adjusting the first group of YCbCr parameters according to the first backlight brightness. The color-space-conversion module converts the second group of YCbCr parameters to the second group of RGB parameters.

The first group of YCbCr parameters includes, for each pixel of a current picture (i.e., the picture to be preloaded), a luma component Y₁, a blue chrominance component Cb₁, and a red chrominance component Cr₁. The second group of YCbCr parameters includes, for each pixel of the current picture, an adjusted luma component Y₂, an adjusted blue chrominance component Cb₂, and an adjusted red chrominance component Cr₂.

In the implementations of the present disclosure, the first group of RGB parameters can be converted into the YCbCr parameters according to a conversion formula as follows.

Y₁=0.299R₁+0.587G₁+0.114B₁

Cb₁=−0.147R₁−0.289G₁+0.436B₁

Cr₁=0.615R₁−0.515G₁−0.100B₁

In the implementations of the present disclosure, the first group of YCbCr parameters can be adjusted according to the first backlight brightness to obtain the second group of YCbCr parameters. Specifically, the luma component in the first group of YCbCr parameters is adjusted, and a blue chrominance component and a red chrominance component remain unchanged, that is, Cb₂=Cb₁, Cr₂=Cr₁, to obtain the second group of YCbCr parameters.

Further, the second group of YCbCr parameters can be converted into the second group of RGB parameters. Specifically, the second group of YCbCr parameters can be converted into the second group of RGB parameters according to another conversion formula as follows.

R₂=Y₂+1.402Cr₂

G₂=Y₂−0.344Cb₁−0.714Cr₂

B₂=Y₂+1.772Cb₂

As an implementation, the color-space-conversion module obtains the second group of YCbCr parameters, by adjusting the first group of YCbCr parameters according to the first backlight brightness as follows.

The color-space-conversion module determines a target adjustment coefficient according to the first backlight brightness. The color-space-conversion module obtains an adjusted luma component, by adjusting a luma component in the first group of YCbCr parameters according to the target adjustment coefficient, and determines the a blue chrominance component and a red chrominance component in the first group of YCbCr parameters and the adjusted luma component as the second group of YCbCr parameters.

In the implementations of the present disclosure, the target adjustment coefficient is used to adjust the first group of YCbCr parameters. Specifically, the luma component in the first group of YCbCr parameters can be adjusted according to the target adjustment coefficient based on the following formula.

Y₂=k*Y₁

k is the target adjustment coefficient.

In the implementations of the present disclosure, the target adjustment coefficient may change with the backlight brightness of the screen. For example, when the backlight brightness of the screen is the first backlight brightness, the target adjustment coefficient can be determined to be a first value. When the backlight brightness of the screen is a second backlight brightness, the target adjustment coefficient can be determined to be a second value. Therefore, when the backlight brightness of the screen is adjusted to the first backlight brightness, the target adjustment coefficient can be determined according to the first backlight brightness.

As an implementation, the color-space-conversion module determines the target adjustment coefficient according to the first backlight brightness as follows.

The color-space-conversion module searches for an adjustment coefficient corresponding to the first backlight brightness from an adjustment coefficient list. The color-space-conversion module determines the adjustment coefficient corresponding to the first backlight brightness as the target adjustment coefficient on condition that the first backlight brightness exists in the adjustment coefficient list.

In the implementations of the present disclosure, multiple adjustment coefficients corresponding to multiple different backlight brightness (values) can be counted in advance, and the adjustment coefficient list can be created according to the multiple backlight brightness (i.e., multiple backlight brightness values) and the multiple adjustment coefficients, so that the adjustment coefficient corresponding to the first backlight brightness can be searched for through the adjustment coefficient list.

As an implementation, the color-space-conversion module determines the target adjustment coefficient according to the first backlight brightness as follows.

The color-space-conversion module obtains multiple backlight brightness samples and obtaining multiple adjustment coefficients by obtaining an adjustment coefficient corresponding to each of the multiple backlight brightness samples. The color-space-conversion module obtains a fitting function by performing fitting according to the multiple backlight brightness samples and the multiple adjustment coefficients. The color-space-conversion module determines the target adjustment coefficient according to the first backlight brightness and the fitting function.

For example, the multiple backlight brightness samples are obtained in advance, and an adjustment coefficient corresponding to each of the multiple backlight brightness samples is obtained so as to obtain the multiple adjustment coefficients. Perform fitting according to the multiple backlight brightness samples and the multiple adjustment coefficients to obtain a fitting function. An independent variable of the fitting function is a backlight brightness (value), and a dependent variable of the fitting function is an adjustment coefficient. Therefore, the first backlight brightness can be brought into the fitting function to obtain the target adjustment coefficient.

At block 203, the screen displays the picture to be loaded according to the second group of RGB parameters.

In the implementations of the present disclosure, after the first group of RGB parameters of the picture to be loaded are adjusted to the second group of RGB parameters, the bridge IC can transmit picture information, including the second group of RGB parameters, of the picture to be displayed to the screen through the MIPI bus. Therefore, the screen can display the picture to be loaded according to the second group of RGB parameters. In this way, brightness of display contents of the picture to be loaded can be adjusted on the basis of the first backlight brightness, so that the display brightness can be adjusted to brightness required by the user. As such, the display contents of the picture to be loaded can be can be seen by the user in brightness determined by two parts: the first backlight brightness and the brightness of display contents of the picture to be loaded.

In the implementations of the present disclosure, in the process of adjusting the first group of RGB parameters to the second group of RGB parameters, the luma component in the first group of YCbCr parameters is adjusted to obtain the adjusted luma component. Since only the luma component in the first group of YCbCr parameters is adjusted and the blue chrominance component and the red chrominance component in the first group of YCbCr parameters are not adjusted, Cb reflects a difference between brightness of a blue part in the RGB color space and RGB brightness, and Cr reflects a difference between brightness of a red part in the RGB color space and the RGB brightness, therefore, by adjusting only the luma component Y₁, the influence of color levels (caused mainly by change in Cb and Cr) can be reduced in the process of adjusting the brightness of the display contents of the picture to be loaded, so as to ensure the display color effect of the display contents of the picture to be loaded.

As an implementation, the following can be further implemented after the color-space-conversion module obtains the adjusted luma component, by adjusting the luma component in the first group of YCbCr parameters according to the target adjustment coefficient.

The AP selects a target pixel area in the picture to be loaded, where pixels in the target pixel area have a luma component greater than a preset luma component. The screen displays the target pixel area in the picture to be loaded according to the second group of RGB parameters and displays pixels not in (beyond) the target pixel area according to the first group of RGB parameters.

As an implementation, the selection of target pixel area can also be performed after the first backlight brightness in the backlight brightness progress bar is detected and it is detected that the first backlight brightness is less than the threshold. In this way, only the first group of RGB parameters of the target pixel area are converted into the second group of RGB parameters according to the first backlight brightness, thereby improving the display speed after adjustment.

Specifically, the method further includes that after detecting, through the AP, the first backlight brightness in the backlight brightness progress bar, the AP selects a target pixel area in the picture to be loaded, where pixels in the target pixel area have a luma component greater than a preset luma component. Therefore, the color-space-conversion module adjusts the first group of RGB parameters of the picture to be loaded to the second group of RGB parameters according to the first backlight brightness by adjusting the first group of RGB parameters of the target pixel area in the picture to be loaded to the second group of RGB parameters according to the first backlight brightness; the screen displays the picture to be loaded according to the second group of RGB parameters by displaying the target pixel area in the picture to be loaded according to the second group of RGB parameters.

As an implementation, the screen displays pixels not in the target pixel area according to the first group of RGB parameters.

In the implementations of the present disclosure, considering that there may exist a relatively bright area and a relatively dark area in the picture to be loaded, if brightness of the relatively dark area is further reduced, the display effect of display contents in the relatively dark pixel area may be affected. Therefore, only the target pixel area, in which pixels have the luma component greater than the preset luma component, in the picture to be loaded is displayed according to the second group of RGB parameters. As such, the original relatively dark pixel area in the picture to be loaded can be ensured not to become darker. For example, in the picture to be loaded, there may exist some texts with lower brightness, that is, the luma component in pixels corresponding to the texts is less, therefore, the texts with lower brightness can be displayed according to the first group of RGB parameters, thus ensuring that the user can see clearly the texts with lower brightness.

By means of the display-brightness adjustment method described in the implementations of the present disclosure, the AP detects the first backlight brightness in the backlight brightness progress bar. The color-space-conversion module adjusts the first group of RGB parameters of the picture to be loaded to the second group of RGB parameters according to the first backlight brightness in response to the first backlight brightness being less than the threshold. The screen displays the picture to be loaded according to the second group of RGB parameters. As such, brightness of display contents can be further adjusted on condition that backlight adjustment of the screen is limited, so as to improve the intelligence of display-brightness adjustment.

FIG. 4 is a schematic flow chart illustrating a method for display-brightness adjustment according to other implementations. The method for display-brightness adjustment described in the implementations is for an electronic device as illustrated in FIG. 1. The electronic device includes an application processor (AP), a bridge chip (IC), and a screen. The bridge IC includes a color-space-conversion module. The AP is coupled with the bridge IC and the bridge IC is coupled with the screen. As illustrated in FIG. 4, the method includes the following.

At block 401, the AP detects a first backlight brightness in a backlight brightness progress bar.

At block 402, the color-space-conversion module obtains a first group of YCbCr parameters, by converting the first group of RGB parameters into YCbCr parameters, on condition that the first backlight brightness being less than a threshold.

At block 403, the color-space-conversion module obtains a second group of YCbCr parameters, by adjusting the first group of YCbCr parameters according to the first backlight brightness.

At block 404, the color-space-conversion module converts the second group of YCbCr parameters to the second group of RGB parameters.

At block 405, the screen displays the picture to be loaded according to the second group of RGB parameters.

For the specific implementations of the above operations at blocks 401-405, reference can be made to corresponding descriptions of operations at blocks 201-203, which will not be repeated here.

By means of the display-brightness adjustment method described in the implementations of the present disclosure, the AP detects the first backlight brightness in the backlight brightness progress bar. On condition that the first backlight brightness being less than a threshold, the color-space-conversion module obtains the first group of YCbCr parameters, by converting the first group of RGB parameters into YCbCr parameters through the color-space-conversion module. The color-space-conversion module obtains the second group of YCbCr parameters, by adjusting the first group of YCbCr parameters according to the first backlight brightness. The color-space-conversion module converts the second group of YCbCr parameters to the second group of RGB parameters, and the screen displays the picture to be loaded according to the second group of RGB parameters. As such, YCbCr parameters of each pixel in the picture to be loaded can be further adjusted on condition that backlight adjustment of the screen is limited, so as to improve the intelligence of display-brightness adjustment.

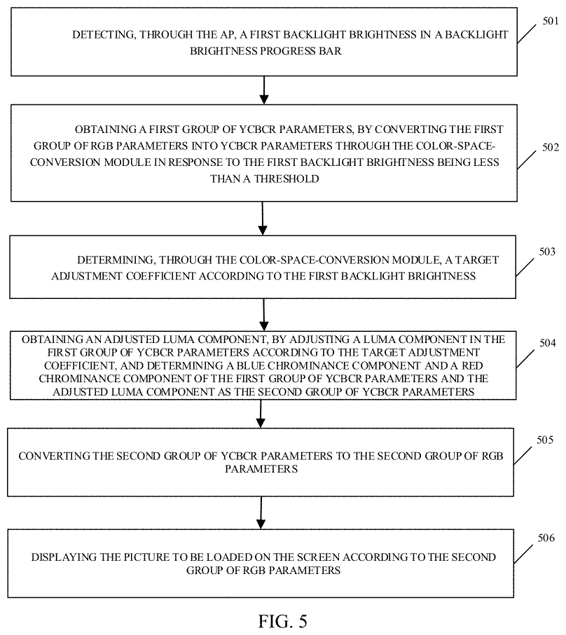

FIG. 5 is a schematic flow chart illustrating a method for display-brightness adjustment according to other implementations. The method for display-brightness adjustment described in the implementations is for an electronic device as illustrated in FIG. 1. The electronic device includes an application processor (AP), a bridge chip (IC), and a screen. The bridge IC includes a color-space-conversion module. The AP is coupled with the bridge IC and the bridge IC is coupled with the screen. As illustrated in FIG. 5, the method includes the following.

At block 501, the AP detects a first backlight brightness in a backlight brightness progress bar.

At block 502, the color-space-conversion module obtains a first group of YCbCr parameters, by converting the first group of RGB parameters into YCbCr parameters, in response to the first backlight brightness being less than a threshold.

At block 503, the color-space-conversion module determines a target adjustment coefficient according to the first backlight brightness.

At block 504, the color-space-conversion module obtains an adjusted luma component, by adjusting a luma component in the first group of YCbCr parameters according to the target adjustment coefficient, and determines a blue chrominance component and a red chrominance component in the first group of YCbCr parameters and the adjusted luma component as the second group of YCbCr parameters.

At block 505, the color-space-conversion module converts the second group of YCbCr parameters to the second group of RGB parameters.

At block 506, the screen displays the picture to be loaded according to the second group of RGB parameters.

For the specific implementations of the above operations at blocks 501-506, reference can be made to corresponding descriptions of operations at blocks 201-203, which will not be repeated here.

By means of the display-brightness adjustment method described in implementations of the present disclosure, the AP detects the first backlight brightness in the backlight brightness progress bar. In response to the first backlight brightness being less than a threshold, the color-space-conversion module obtains the first group of YCbCr parameters, by converting the first group of RGB parameters into YCbCr parameters through the color-space-conversion module. The color-space-conversion module determines a target adjustment coefficient according to the first backlight brightness. The color-space-conversion module obtains an adjusted luma component, by adjusting a luma component in the first group of YCbCr parameters according to the target adjustment coefficient, and determines a blue chrominance component and a red chrominance component in the first group of YCbCr parameters and the adjusted luma component as the second group of YCbCr parameters. The screen displays the picture to be loaded according to the second group of RGB parameters. As such, YCbCr parameters of each pixel in the picture to be loaded can be further adjusted on condition that backlight adjustment of the screen is limited, so as to improve intelligence of display-brightness adjustment.

The following describes devices for implementing the above display-brightness adjustment method, which is specifically as follows.

FIG. 6 is a schematic structural diagram illustrating an electronic device according to other implementations. As illustrated in FIG. 6, the electronic device includes an AP, a bridge IC, a screen, an communication interface, a memory, and one or more programs stored in the memory. The one or more programs are configured to be executed by the processor (i.e., AP) and include instructions configured to perform the following operations.

A first backlight brightness in a backlight brightness progress bar is detected. A first group of RGB parameters of a picture to be loaded is adjusted to a second group of RGB parameters according to the first backlight brightness in response to the first backlight brightness being less than a threshold. The picture to be loaded is displayed according to the second group of RGB parameters.

As an implementation, in terms of adjusting the first group of RGB parameters of the picture to be loaded to the second group of RGB parameters according to the first backlight brightness, the one or more programs include instructions configured to perform the following operations. A first group of YCbCr parameters is obtained by converting the first group of RGB parameters into YCbCr parameters. A second group of YCbCr parameters is obtained by adjusting the first group of YCbCr parameters according to the first backlight brightness. The second group of YCbCr parameters is converted to the second group of RGB parameters.

As an implementation, in terms of obtaining the second group of YCbCr parameters, by adjusting the first group of YCbCr parameters according to the first backlight brightness, the one or more programs include instructions configured to perform the following operations. A target adjustment coefficient is determined according to the first backlight brightness. An adjusted luma component is obtained by adjusting a luma component in the first group of YCbCr parameters according to the target adjustment coefficient, and a blue chrominance component and a red chrominance component in the first group of YCbCr parameters and the adjusted luma component are determined as the second group of YCbCr parameters.

As an implementation, in terms of determining the target adjustment coefficient according to the first backlight brightness, the one or more programs include instructions configured to perform the following operations. An adjustment coefficient corresponding to the first backlight brightness is searched for from an adjustment coefficient list. The adjustment coefficient corresponding to the first backlight brightness is determined as the target adjustment coefficient on condition that the first backlight brightness exists in the adjustment coefficient list.

As an implementation, in terms of determining the target adjustment coefficient according to the first backlight brightness, the one or more programs include instructions configured to perform the following operations. Multiple backlight brightness samples are obtained and multiple adjustment coefficients corresponding to each of the multiple backlight brightness samples are obtained. A fitting function is obtained by performing fitting according to the multiple backlight brightness samples and the multiple adjustment coefficients. The target adjustment coefficient is determined according to the first backlight brightness and the fitting function.

The one or more programs further include instructions configured to perform the following operations. After the adjusted luma component is obtained, by adjusting the luma component in the first group of YCbCr parameters according to the target adjustment coefficient, a target pixel area in the picture to be loaded is selected, where pixels in the target pixel area have a luma component greater than a preset luma component. The target pixel area in the picture to be loaded is displayed according to the second group of RGB parameters. Pixels not in the target pixel area are displayed according to the first group of RGB parameters.

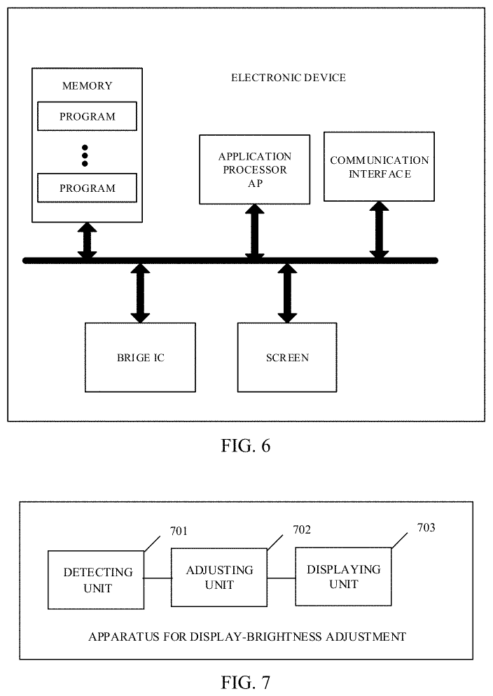

FIG. 7 is a schematic structural diagram illustrating an apparatus for display-brightness adjustment according to implementations. As illustrated in FIG. 7, the apparatus for display-brightness adjustment includes a detecting unit 701, an adjusting unit 702, and a displaying unit 703.

The detecting unit 701 is configured to detect a first backlight brightness in a backlight brightness progress bar.

The adjusting unit 702 is configured to adjust a first group of RGB parameters of a picture to be loaded to a second group of RGB parameters according to the first backlight brightness in response to the first backlight brightness being less than a threshold.

The displaying unit 703 is configured to display the picture to be loaded according to the second group of RGB parameters.

As an implementation, in terms of adjusting the first group of RGB parameters of the picture to be loaded to the second group of RGB parameters according to the first backlight brightness, the adjusting unit 702 is configured to: obtain a first group of YCbCr parameters, by converting the first group of RGB parameters into YCbCr parameters; obtain a second group of YCbCr parameters, by adjusting the first group of YCbCr parameters according to the first backlight brightness; convert the second group of YCbCr parameters to the second group of RGB parameters.

As an implementation, in terms of obtaining the second group of YCbCr parameters, by adjusting the first group of YCbCr parameters according to the first backlight brightness, the adjusting unit 702 is configured to: determine a target adjustment coefficient according to the first backlight brightness; obtain an adjusted luma component, by adjusting a luma component in the first group of YCbCr parameters according to the target adjustment coefficient, and determine a blue chrominance component and a red chrominance component in the first group of YCbCr parameters and the adjusted luma component as the second group of YCbCr parameters.

As an implementation, in terms of determining the target adjustment coefficient according to the first backlight brightness, the adjusting unit 702 is configured to: search for an adjustment coefficient corresponding to the first backlight brightness from an adjustment coefficient list; determine the adjustment coefficient corresponding to the first backlight brightness as the target adjustment coefficient on condition that the first backlight brightness exists in the adjustment coefficient list.

As an implementation, in terms of determining the target adjustment coefficient according to the first backlight brightness, the adjusting unit 702 is configured to: obtain multiple backlight brightness samples and obtaining multiple adjustment coefficients corresponding to each of the multiple backlight brightness samples; obtain a fitting function by performing fitting according to the multiple backlight brightness samples and the multiple adjustment coefficients; determine the target adjustment coefficient according to the first backlight brightness and the fitting function.

As an implementation, the adjusting unit 702 is further configured to select a target pixel area in the picture to be loaded, where pixels in the target pixel area have a luma component greater than a preset luma component, after obtaining the adjusted luma component, by adjusting the luma component in the first group of YCbCr parameters according to the target adjustment coefficient. The displaying unit 703 is further configured to display the target pixel area in the picture to be loaded according to the second group of RGB parameters; display pixels not in the target pixel area according to the first group of RGB parameters.

By means of the apparatus for display-brightness adjustment, the first backlight brightness in the backlight brightness progress bar is detected. The first group of RGB parameters of the picture to be loaded is adjusted to the second group of RGB parameters according to the first backlight brightness in response to the first backlight brightness being less than the threshold. The picture to be loaded is displayed according to the second group of RGB parameters. As such, brightness of display contents can be further adjusted on condition that backlight adjustment of the screen is limited, so as to improve intelligence of display-brightness adjustment.

It can be understandable that the functions of each program modules of the apparatus for display-brightness adjustment in the implementations can be implemented according to the method in the above method implementations, and reference of a specific implementation process can be made to the relevant descriptions in the above method implementations, which will not be repeated here.

It is to be noted that, the apparatus for display-brightness adjustment described in the device implementation of the disclosure is presented in the form of functional units. The term “unit” used herein should be understood as the broadest meaning as possible, and an object for implementing functions defined by each “unit” may be, for example, an integrated circuit (ASIC), a single circuit, a processor (shared, dedicated, or chipset) and a memory for executing one or more software or firmware programs, a combinational logic circuit, and/or other suitable components that can achieve the above described functions.

Implementations of the present disclosure also provide another electronic device. For ease of description, only parts related to implementations of the present disclosure are described and for specific technical details that are not described, reference can be made to method implementations of the present disclosure. The electronic device can include a mobile phone, a tablet computer, a personal digital assistant (PDA), a point of sales (POS), a vehicle-mounted computer, and other mobile devices. A mobile phone will be taken as an example of the electronic device in the following.

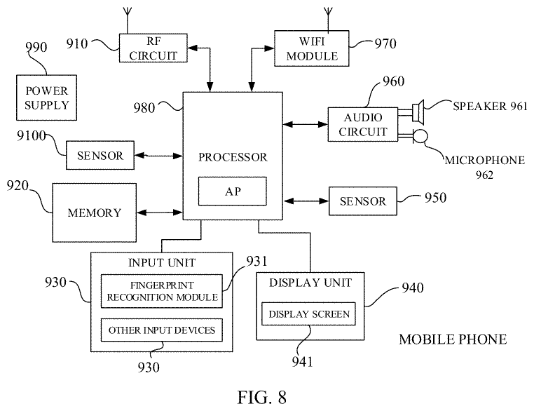

FIG. 8 is a schematic structural diagram of a part of structure s of a mobile terminal that is related to the mobile terminal provided in implementations. As illustrated in FIG. 8, the mobile phone includes: a radio frequency (RF) circuit 910, a memory 920, an input unit 930, a display unit 940, a sensor 950, an audio circuit 960, a wireless fidelity (Wi-Fi) module 970, a processor 980, a power supply 990, and other elements. It will be appreciated by those skilled in the art that the present disclosure is not limited by the mobile terminal as illustrated in FIG. 8. More or fewer elements than that as illustrated in FIG. 8 can be included, some elements may be or combined, or elements can be arranged differently.

Hereinafter, detailed description of each element of the mobile terminal will be given below with reference of FIG. 8.

The RF circuit 910 can be configured to receive and transmit information. Generally, the RF circuit 910 includes but is not limited to an antenna, at least one amplifier, a transceiver, a coupler, a low noise amplifier (LNA), a duplexer, and the like. Furthermore, the RF circuit 910 may also be configured to communicate with a network and other devices via wireless communication. The above wireless communication may use any communication standard or protocol, which includes but is not limited to global system of mobile communication (GSM), general packet radio service (GPRS), code division multiple access (CDMA), wideband code division multiple access (WCDMA), long term evolution (LTE), E-mail, short messaging service (SMS), and so on.

The memory 920 is configured to store software programs and modules. The processor 980 is configured to execute various function applications and data processing of the mobile phone by running the software programs and the modules stored in the memory 920. The memory 920 can mainly include a program storage area and a data storage area. The program storage area can store an operating system, applications required for at least one function (such as a data backup function, a function of scanning two-dimensional code, and a function of determining compatibility), and so on. The data storage area can store data (such as the first data set and the second data set backed up) created according to use of the mobile phone, and so on. In addition, the memory 920 can include a high-speed RAM, and can further include a non-volatile memory such as at least one disk storage device, a flash device, or other non-volatile solid storage devices.

The input unit 930 is configured to receive input digital or character information and to generate key signal input associated with user setting and functional control of the mobile phone. In some possible implementations, the input unit 930 may include a fingerprint identification module 931 and other input devices 932. The fingerprint identification module 931 is configured to collect use's fingerprint data thereon. The input unit 930 can further include other input devices 932 in addition to the fingerprint identification module 931. Specifically, the other input devices 932 can include, but are not limited to, one or more of a physical keyboard, a functional key (such as a volume control key, a switch key, and so on), a track ball, a mouse, and an operating rod.

The display unit 940 is configured to display information input by the user, information provided for the user, or various menus of the mobile phone. The display unit 940 can include a display panel 941, and in some possible implementations, the display panel 941 may be configured in the form of a liquid crystal display (LCD), an organic light-emitting diode (OLED), and so on.

The mobile phone may also include at least one sensor 950, such as a light sensor, a motion sensor, and other sensors. As an implementation, the light sensor may include an ambient light sensor and a proximity sensor. The ambient light sensor can be configured to adjust the brightness of the display panel 941 according to ambient lights, and the proximity sensor can be configured to turn off the display panel 941 and/or backlight when the mobile phone reaches nearby the ear. As one kind of motion sensor, an accelerometer sensor can be configured to detect the magnitude of acceleration in different directions (typically three axes) and the accelerometer sensor can also be configured to detect the magnitude and direction of gravity when mobile phone is stationary. The accelerometer sensor can also be configured to identify mobile-phone gestures related applications (such as vertical and horizontal screen switch, related games, magnetometer attitude calibration), and can be used for vibration-recognition related functions (such as a pedometer, or percussion), and so on. The mobile phone can also be equipped with other sensors such as a gyroscope, a barometer, a hygrometer, a thermometer, an infrared sensor, etc., which will not be repeated herein.

The audio circuit 960, the speaker 991, and the microphone 992 can provide an audio interface between the user and the mobile phone. The audio circuit 960 can be configured to convert received audio data into electrical signals and transfer the electrical signals to the speaker 991; the speaker 991 is configured to convert the electrical signals received into sound signals for output. On the other hand, the microphone 992 is configured to convert the received sound signals into electrical signals, which will be received and then converted into audio data by the audio circuit 960. The audio data is then transmitted to the processor 980 to be processed. The audio data processed by the processor 980 is transmitted to another mobile phone via an RF circuit 910 for example or is output to the memory 920 for further processing.

Wi-Fi belongs to a short-range wireless transmission technology. With aid of the Wi-Fi module 970, the mobile phone may assist the user in E-mail receiving and sending, webpage browsing, access to streaming media, and the like. Wi-Fi provides users with wireless broadband Internet access. Although the Wi-Fi module 970 is illustrated in FIG. 8, it is to be noted that the Wi-Fi module 970 is not essential to the mobile phone and can be omitted according to actual needs without departing from the essential nature of the present disclosure.

The processor 980 is a control center of the mobile phone, and is configured to connect all parts of the whole mobile phone by utilizing various interfaces and lines, to run or execute the software programs and/or the modules stored in the memory 920, and to call data stored in the memory 920 to execute various functions and data processing of the mobile phone, so as to monitor the mobile phone as a whole. Optionally, in some implementations, the processor 980 can include one or more processing units. In some possible implementations, the processor 980 may be integrated with an application processor and a modulation-demodulation processor. The application processor is mainly configured to process an operating system, a user interface, an application program, and the like, and the modulation-demodulation processor is mainly configured to process wireless communication. It can be noted that the modulation-demodulation processor may not be integrated into the processor 980.

The mobile phone also includes a power supply 990 (e.g., a battery) that supplies power to various elements. For instance, the power supply 990 may be logically connected to the processor 980 via a power management system to achieve management of charging, discharging, and power consumption through the power management system.

The mobile phone also includes a camera 9100, and the camera 9100 is configured to capture images and videos and transmit the images and videos captured to the processor 980 for processing.

Although not illustrated, the mobile phone may include a Bluetooth® module, etc., and the present disclosure will not elaborate herein.

The methods of the foregoing implementations as illustrated in FIGS. 2, 4, 5 can be implemented based on the structure of the mobile terminal illustrated in FIG. 8.

A non-transitory computer storage medium is also provided. The non-transitory computer storage medium is configured to store programs which, when executed, are operable to execute some or all of the steps of any of the methods for display-brightness adjustment as described in the above-described method implementations. The computer may include an electronic device.

A computer program product is also provided. The computer program product includes a non-transitory computer-readable storage medium that stores computer programs. The computer programs are operable with a computer to execute some or all operations of the method display-brightness adjustment as described in the above-described method implementations. The computer may include an electronic device.

It is to be noted that, for the sake of simplicity, the foregoing method implementations are described as a series of action combinations. However, it will be appreciated by those skilled in the art that the present disclosure is not limited by the sequence of actions described. According to the present disclosure, certain steps or operations may be performed in other order or simultaneously. Besides, it will be appreciated by those skilled in the art that the implementations described in the specification are exemplary implementations and the actions and modules involved are not necessarily essential to the present disclosure.

In the foregoing implementations, the description of each implementation has its own emphasis. For the parts not described in detail in an implementation, reference may be made to related descriptions in other implementations.

In the implementations of the present disclosure, it is to be noted that, the apparatus disclosed in implementations provided herein may be implemented in other manners. For example, the device/apparatus implementations described above are merely illustrative; for instance, the division of the unit is only a logical function division and there can be other manners of division during actual implementations; for example, multiple units or components may be combined or may be integrated into another system, or some features may be ignored, omitted, or not performed. In addition, coupling or communication connection between each illustrated or discussed component may be direct coupling or communication connection, may be indirect coupling or communication among devices or units via some interfaces, and may be electrical connection, mechanical connection, or other forms of connection.

The units described as separate components may or may not be physically separated, and the components illustrated as units may or may not be physical units, that is, they may be in the same place or may be distributed to multiple network elements. All or part of the units may be selected according to actual needs to achieve the purpose of the technical solutions of the implementations.

In addition, the functional units in various implementations of the present disclosure may be integrated into one processing unit, or each unit may be physically present, or two or more units may be integrated into one unit. The above-mentioned integrated unit can be implemented in the form of hardware or a software function unit.

The integrated unit may be stored in a computer-readable memory when it is implemented in the form of a software functional unit and is sold or used as a separate product. Based on such understanding, the technical solutions of the present disclosure essentially, or the part of the technical solutions that contributes to the related art, or all or part of the technical solutions, may be embodied in the form of a software product which is stored in a memory and includes instructions for causing a computer device (which may be a personal computer, a server, or a network device, and so on) to perform all or part of the steps described in the various implementations of the present disclosure. The memory includes various medium capable of storing program codes, such as a USB (universal serial bus) flash disk, a read-only memory (ROM), a random access memory (RAM), a removable hard disk, Disk, compact disc (CD), or the like.

It will be noted by those of ordinary skill in the art that all or a part of the various methods of the implementations described above may be accomplished by means of a program to instruct associated hardware, where the program may be stored in a computer-readable memory, which may include a flash memory, a read-only memory (ROM), a random-access memory (RAM), a disk or a compact disc (CD), and so on.

The implementations of the present disclosure are described in detail above, specific examples are used herein to describe the principle and implementation manners of the present disclosure. The description of the above implementations is merely used to help understand the method and the core idea of the present disclosure. Meanwhile, those skilled in the art may make modifications to the specific implementation manners and the application scope according to the idea of the present disclosure. In summary, the contents of the specification should not be construed as limiting the present disclosure.

What is claimed is:

1. A method for display-brightness adjustment, for an electronic device comprising an application processor (AP), a bridge chip (IC), and a screen, the bridge IC comprising a color-space-conversion module, the AP being coupled with the bridge IC, the bridge IC being coupled with the screen, and the method comprising:
detecting, through the AP, a first backlight brightness in a backlight brightness progress bar;
adjusting, through the color-space-conversion module, a first group of RGB parameters of a picture to a second group of RGB parameters according to the first backlight brightness in response to the first backlight brightness being less than a threshold; and
displaying the picture on the screen according to the second group of RGB parameters.

2. The method of claim 1, wherein adjusting, through the color-space-conversion module, the first group of RGB parameters of the picture to the second group of RGB parameters according to the first backlight brightness comprises:
obtaining a first group of YCbCr parameters, by converting the first group of RGB parameters into YCbCr parameters through the color-space-conversion module;
obtaining a second group of YCbCr parameters, by adjusting the first group of YCbCr parameters according to the first backlight brightness; and
converting the second group of YCbCr parameters to the second group of RGB parameters.

3. The method of claim 2, wherein obtaining the second group of YCbCr parameters, by adjusting the first group of YCbCr parameters according to the first backlight brightness comprises:
determining, through the color-space-conversion module, a target adjustment coefficient according to the first backlight brightness; and
obtaining an adjusted luma component, by adjusting a luma component in the first group of YCbCr parameters according to the target adjustment coefficient, and determining a blue chrominance component and a red chrominance component in the first group of YCbCr parameters and the adjusted luma component as the second group of YCbCr parameters.

4. The method of claim 3, wherein determining, through the color-space-conversion module, the target adjustment coefficient according to the first backlight brightness comprises:
searching, through the color-space-conversion module, for an adjustment coefficient corresponding to the first backlight brightness from an adjustment coefficient list; and
determining the adjustment coefficient corresponding to the first backlight brightness as the target adjustment coefficient.

5. The method of claim 3, wherein determining, through the color-space-conversion module, the target adjustment coefficient according to the first backlight brightness comprises:
obtaining, through the color-space-conversion module, a plurality of backlight brightness samples and obtaining a plurality of adjustment coefficients corresponding to each of the plurality of backlight brightness samples;
obtaining a fitting function by performing fitting according to the plurality of backlight brightness samples and the plurality of adjustment coefficients; and
determining the target adjustment coefficient according to the first backlight brightness and the fitting function.

6. The method of claim 3, further comprising:
after obtaining the adjusted luma component, by adjusting the luma component in the first group of YCbCr parameters according to the target adjustment coefficient:
selecting a target pixel area in the picture through the AP, pixels in the target pixel area having a luma component greater than a preset luma component;
displaying the target pixel area in the picture according to the second group of RGB parameters; and
displaying pixels not in the target pixel area according to the first group of RGB parameters.

7. The method of claim 1, further comprising:
after detecting, through the AP, the first backlight brightness in the backlight brightness progress bar:
selecting a target pixel area in the picture through the AP, pixels in the target pixel area having a luma component greater than a preset luma component;
wherein adjusting, through the color-space-conversion module, the first group of RGB parameters of the picture to the second group of RGB parameters according to the first backlight brightness comprises:
adjusting, through the color-space-conversion module, the first group of RGB parameters of the target pixel area in the picture to the second group of RGB parameters according to the first backlight brightness; and
wherein displaying the picture on the screen according to the second group of RGB parameters comprises:
displaying the target pixel area in the picture on the screen according to the second group of RGB parameters.

8. The method of claim 7, further comprising:
displaying pixels not in the target pixel area on the screen according to the first group of RGB parameters.

9. An electronic device comprising an application processor (AP), a bridge chip (IC), and a screen, the bridge IC comprising a color-space-conversion module, the AP being coupled with the bridge IC, the bridge IC being coupled with the screen, wherein:
the AP is configured to detect a first backlight brightness in a backlight brightness progress bar;
the color-space-conversion module is configured to adjust a first group of RGB parameters of a picture to a second group of RGB parameters according to the first backlight brightness in response to the first backlight brightness being less than a threshold; and
the screen is configured to display the picture according to the second group of RGB parameters.

10. The electronic device of claim 9, wherein in terms of adjusting, through the color-space-conversion module, the first group of RGB parameters of the picture to the second group of RGB parameters according to the first backlight brightness, the color-space-conversion module is configured to:
obtain a first group of YCbCr parameters by converting the first group of RGB parameters into YCbCr parameters;
obtain a second group of YCbCr parameters, by adjusting the first group of YCbCr parameters according to the first backlight brightness; and
convert the second group of YCbCr parameters to the second group of RGB parameters.

11. The electronic device of claim 10, wherein in terms of obtaining the second group of YCbCr parameters, by adjusting the first group of YCbCr parameters according to the first backlight brightness, the color-space-conversion module is configured to:
determine a target adjustment coefficient according to the first backlight brightness; and
obtain an adjusted luma component, by adjusting a luma component in the first group of YCbCr parameters according to the target adjustment coefficient, and determine a blue chrominance component and a red chrominance component in the first group of YCbCr parameters and the adjusted luma component as the second group of YCbCr parameters.

12. The electronic device of claim 11, wherein in terms of determining the target adjustment coefficient according to the first backlight brightness, the color-space-conversion module is configured to:
search for an adjustment coefficient corresponding to the first backlight brightness from an adjustment coefficient list; and
determine the adjustment coefficient corresponding to the first backlight brightness as the target adjustment coefficient.

13. The electronic device of claim 11, wherein in terms of determining the target adjustment coefficient according to the first backlight brightness, the color-space-conversion module is configured to:
obtain a plurality of backlight brightness samples and obtain a plurality of adjustment coefficients corresponding to each of the plurality of backlight brightness samples;
obtain a fitting function by performing fitting according to the plurality of backlight brightness samples and the plurality of adjustment coefficients; and
determine the target adjustment coefficient according to the first backlight brightness and the fitting function.

14. The electronic device of claim 11, wherein:
the AP is further configured to select, from the picture, a target pixel area in which pixels have a luma component greater than a preset luma component after the color-space-conversion module obtains the adjusted luma component, by adjusting the luma component in the first group of YCbCr parameters according to the target adjustment coefficient;
the screen is further configured to display the target pixel area in the picture according to the second group of RGB parameters; and display pixels not in the target pixel area according to the first group of RGB parameters.

15. The electronic device of claim 9, wherein:
the AP is further configured to select a target pixel area in the picture after the AP detects the first backlight brightness in the backlight brightness progress bar, pixels in the target pixel area having a luma component greater than a preset luma component;
the color-space-conversion module configured to adjust the first group of RGB parameters of the picture to the second group of RGB parameters according to the first backlight brightness is configured to adjust the first group of RGB parameters of the target pixel area in the picture to the second group of RGB parameters according to the first backlight brightness comprises; and
the screen configured to display the picture according to the second group of RGB parameters is configured to display the target pixel area in the picture according to the second group of RGB parameters.

16. The electronic device of claim 15, wherein the screen is further configured to display pixels not in the target pixel area according to the first group of RGB parameters.

17. A non-transitory computer-readable storage medium storing a computer program for electronic data interchange, wherein the computer program causes a computer to perform:
detecting a first backlight brightness in a backlight brightness progress bar;
adjusting a first group of RGB parameters of a picture to a second group of RGB parameters according to the first backlight brightness in response to the first backlight brightness being less than a threshold; and
displaying the picture according to the second group of RGB parameters.

18. The non-transitory computer-readable storage medium of claim 17, wherein the computer program causes a computer to perform adjusting the first group of RGB parameters of the picture to the second group of RGB parameters according to the first backlight brightness causes the computer to perform:
obtaining a first group of YCbCr parameters, by converting the first group of RGB parameters into YCbCr parameters;
obtaining a second group of YCbCr parameters, by adjusting the first group of YCbCr parameters according to the first backlight brightness; and
converting the second group of YCbCr parameters to the second group of RGB parameters.

19. The non-transitory computer-readable storage medium of claim 18, wherein the computer program causes a computer to perform obtaining the second group of YCbCr parameters, by adjusting the first group of YCbCr parameters according to the first backlight brightness causes the computer to perform:
determining a target adjustment coefficient according to the first backlight brightness; and
obtaining an adjusted luma component, by adjusting a luma component in the first group of YCbCr parameters according to the target adjustment coefficient, and determining a blue chrominance component and a red chrominance component in the first group of YCbCr parameters and the adjusted luma component as the second group of YCbCr parameters.

20. The non-transitory computer-readable storage medium of claim 17, wherein the computer program further causes a computer to perform:
after detecting the first backlight brightness in the backlight brightness progress bar:
selecting a target pixel area in the picture, pixels in the target pixel area having a luma component greater than a preset luma component;
wherein the computer program causes the computer to perform adjusting the first group of RGB parameters of the picture to the second group of RGB parameters according to the first backlight brightness causes the computer to perform:
adjusting the first group of RGB parameters of the target pixel area in the picture to the second group of RGB parameters according to the first backlight brightness comprises;
wherein the computer program causes the computer to perform displaying the picture according to the second group of RGB parameters causes the computer to perform:
displaying the target pixel area in the picture according to the second group of RGB parameters.
